(19) United States
(12) Patent Application Publication
(10) Pub. No.: US 2024/0403552 A1
(43) Pub. Date: Dec. 5, 2024

(54) ARTIFICIAL-INTELLIGENCE-ASSISTED CONTENT PROCESSING OF CROSS-NETWORK COMMUNICATIONS

(71) Applicant: MDLIVE, Inc., Miramar, FL (US)

(72) Inventors: Michael Shope, Orlando, FL (US); Chuck B. Metturdharma, Bloomfield, CT (US); Lakshmikumari Meerasankaranarayanan, Bloomfield, CT (US); Saul Moncada, Miramar, FL (US)

(21) Appl. No.: 18/734,033

(22) Filed: Jun. 5, 2024

Related U.S. Application Data
(60) Provisional application No. 63/471,194, filed on Jun. 5, 2023.

(51) Int. Cl. G06F 40/205; G10L 15/26

(52) U.S. Cl. CPC G06F 40/205; G10L 15/26

(57) ABSTRACT

A computer-implemented method for processing an audio recording includes obtaining the audio recording of an interaction. The computer-implemented method includes automatically transcribing the audio recording into computer-readable text. The computer-implemented method includes determining a set of artificial intelligence (AI) prompts corresponding to the interaction. The computer-implemented method includes providing the computer-readable text and the set of AI prompts to an AI engine. The computer-implemented method also includes receiving a set of analyses from the AI engine corresponding to the set of AI prompts. determining a feature of merit for the interaction based on the set of analyses. The computer-implemented method includes, in response to the feature of merit, selectively generating a notification and transmitting the notification using a selected communications channel.

### CROSS-REFERENCE TO RELATED APPLICATIONS

This application claims the benefit of U.S. Provisional Application No. 63/471,194 filed Jun. 5, 2023, the entire disclosure of which is incorporated by reference.

### FIELD

The present disclosure relates to speech processing and more particularly to artificial-intelligence-assisted processing of recorded data.

### SUMMARY

A computer-implemented method for processing an audio recording includes obtaining the audio recording of an interaction. The computer-implemented method includes automatically transcribing the audio recording into computer-readable text. The computer-implemented method further includes determining a set of artificial intelligence (AI) prompts corresponding to the interaction. The computer-implemented method includes providing the computer-readable text and the set of AI prompts to an AI engine. The computer-implemented method also includes receiving a set of analyses from the AI engine corresponding to the set of AI prompts. determining a feature of merit for the interaction based on the set of analyses. The computer-implemented method includes, in response to the feature of merit, selectively generating a notification and transmitting the notification using a selected communications channel.

In other features, the audio recording includes a compressed audio file. In other features, the set of AI prompts is universal to all interactions. In other features, each prompt of the set of AI prompts is a text string. In other features, the computer-readable text is plaintext. In other features, the set of analyses from the AI engine is received as a JavaScript Object Notation (JSON) object. In other features, each analysis of the set of analyses is a text string. In other features, each analysis of a subset of the set of analyses is a text string encoding a Boolean value.

In other features, the computer-implemented method includes transforming the set of analyses to create a transformed set of analyses. The feature of merit is based on the transformed set of analyses. In other features, the transforming includes converting data from a first data type to a second data type. In other features, the first data type is a string and the second data type is a Boolean.

In other features, the feature of merit is a summed score and, for the interaction, each analysis of the set of analyses contributes either zero or one to the summed score. In other features, the feature of merit is automatically set to a failing score in response to any one or more of a defined subset of the set of analyses failing to meet satisfaction criteria. In other features, elements of the set of analyses correspond one-to-one with elements of the set of AI prompts.

A computer system includes memory hardware configured to store instructions, and processing hardware configured to execute the instructions. The instructions include obtaining an audio recording of an interaction. The instructions include automatically transcribing the audio recording into computer-readable text. The instructions include determining a set of artificial intelligence (AI) prompts corresponding to the interaction. The instructions include providing the computer-readable text and the set of AI prompts to an AI engine. The instructions include receiving a set of analyses from the AI engine corresponding to the set of AI prompts. The instructions include determining a feature of merit for the interaction based on the set of analyses. The instructions include, in response to the feature of merit, selectively generating a notification and transmitting the notification using a selected communications channel.

In other features, the instructions further include transforming the set of analyses to create a transformed set of analyses. The feature of merit is based on the transformed set of analyses. In other features, the feature of merit is a summed score and, for the interaction, each analysis of the set of analyses contributes either zero or one to the summed score. In other features, the feature of merit is automatically set to a failing score in response to any one or more of a defined subset of the set of analyses failing to meet satisfaction criteria. In other features, elements of the set of analyses correspond one-to-one with elements of the set of AI prompts.

A non-transitory computer-readable medium includes processor-executable instructions that include obtaining an audio recording of an interaction. The instructions include automatically transcribing the audio recording into computer-readable text. The instructions include determining a set of artificial intelligence (AI) prompts corresponding to the interaction. The instructions include providing the computer-readable text and the set of AI prompts to an AI engine. The instructions include receiving a set of analyses from the AI engine corresponding to the set of AI prompts. The instructions include determining a feature of merit for the interaction based on the set of analyses. The instructions include, in response to the feature of merit, selectively generating a notification and transmitting the notification using a selected communications channel.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional data flow diagram representing how data flows between functional components of an example system for artificial-intelligence-assisted content processing of virtual communications according to the present disclosure.

FIG. 2 is a functional block diagram of an example service-based implementation of the present disclosure.

FIG. 3 is a data flow diagram depicting data interactions within an implementation of the present disclosure.

FIG. 4 is a flowchart of example process for processing virtual communications of the present disclosure.

FIG. 5 is a view of a display on a device for selecting rules to be used by the present methods and systems in the present disclosure.

In the drawings, reference numbers may be reused to identify similar and/or identical elements.

### DETAILED DESCRIPTION

### Introduction

An artificial-intelligence-assisted system for processing virtual communications uses generative artificial intelligence to monitor and assess a provider's interaction with patients to determine whether the interaction meets a satisfaction criteria. The provider may interact with the patient using a virtual interaction platform connecting a provider device with a patient device. The provider may be a doctor, nurse, physician's assistant, etc. Each of the provider device and the patient device may be a device capable of connecting to other devices via an internet connection—for example, a desktop computer, a laptop computer, a tablet, a smartwatch or a smartphone.

The interaction may include a text, audio, and/or video recording of a conversation between the patient and the provider. In some implementations, the recording may be a text file, an audio file, or a video file. A transcription module may be used to transcribe the recording into text string, such as, computer-readable text, plain text, etc. In various implementations, the transcribed recording may include speaker and time tags. In various implementations, an artificial intelligence model may be used to transcribe the recording into text. In some implementations, a custom dictionary with medical terms may be used to enhance transcription accuracy.

The transcribed recording may be applied to a generative artificial intelligence model (or other large language model) to determine whether the interaction meets a satisfaction criteria for medical interactions. The satisfaction criteria may include a set of prompts defining desired rules to be followed during a medical interaction. For example, an operator of the virtual interaction platform may define rules for interactions between providers and patients. The rules may include requirements for a physician to comply with in order to provide effective medical service. For example, the rules may be defined based on laws, regulations, medical best practices, legal best practices, patient preferences, and/or health insurer preferences. In various implementations, the provider may be responsible for knowing and following these rules during virtual interactions.

In various implementations, examples of these rules include beginning the virtual interaction with verifying the patient's name, date of birth, location, medication list, medical history, and allergies. The rules may also include the provider fully introducing themselves, providing their qualifications, and clearly indicating that the virtual interaction is being recorded. A rule based on laws can include, for a patient whose age is below an age threshold—for example, the age of majority (18 in some jurisdictions) or another threshold—verifying that a guardian is present for the minor. This verification may take the form of the patient verifying that the guardian is present or the guardian themselves verifying their presence.

In various implementations, each rule or aspect of a rule may be encoded as a separate prompt. As one example, the prompt for whether the provider introduced themselves may include the natural language query “Did the provider say their name?” In various implementations, an artificial intelligence model may be used to encode each rule into a prompt. In some implementations, the operator may provide specific prompt data, such as phrases and questions to the generative artificial intelligence model to analyze transcribed interaction recordings. Additionally, the model can adapt to identify different forms the specific prompt. In various implementations, the artificial intelligence model may be configured to autonomously adapt the prompts based on feedback regarding how accurately the generative artificial intelligence model has assessed adherence to or deviation from a rule over time.

The generative artificial intelligence model may be configured to analyze the transcribed recording based on adherence of the transcribed recording to the prompts. The generative artificial intelligence model may output a set of analyses with a one-to-one correspondence to the prompts. The set of analyses may include answers to the prompts. An adherence of the provider to the prompts may be determined based on the analyses. In some implementations, a score of the interaction may be determined based on the set of analyses. The score may simply be the number of rules/prompts that were correctly followed. In various implementations, the adherence may be provided as a satisfaction criteria including an output of pass or fail. This pass or fail output may be based on how many rules/prompts were followed during the interaction. For example, if the provider deviated from two or fewer rules/prompts, this might be considered a pass, while three or more rule/prompt deviations would be considered a fail.

In various implementations, there may be a hierarchy of rules/prompts such that—for a subset of rules/prompts—deviation from any one rule/prompt in the subset results in a fail or a score of zero in every instance. The generative artificial intelligence model may also encode Boolean and algebraic logic for determining whether an interaction was a success or failure as well as algorithms to calculate a score for each interaction. For example, deviation from a high priority rule/prompt may automatically result in a score of zero as a Boolean value. Otherwise, if the highest priority rules/prompts are all followed, the score may reflect the adherence to the lower priority rules/prompts. The model can order the rules to analyze the patient visit for the high priority rules before the medium priority rules and the low priority rules.

The interaction scores may then be used to monitor the adherence of providers. For example, an overall provider score, such as an average of interaction scores across all of a provider's interactions, may be calculated. In various implementations, an exponentially weighted average may be used to more strongly weight more recent interactions in the overall provider score. Other statistical analyses may also be performed across various categories, such as type of provider, provider network, provider location, etc. based on the interaction scores. The interaction scores can be used to pinpoint areas for a physician to improve in future interactions. The scores can also be used to determine additional training data to improve the provider interactions across the various categories.

### Storage Device

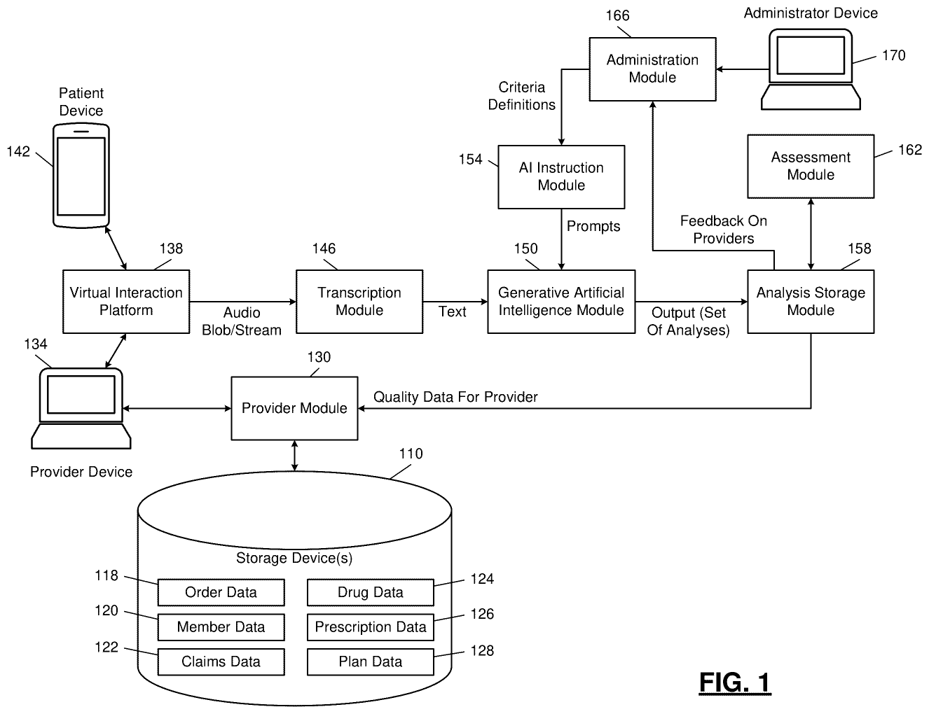

FIG. 1 is a functional data flow diagram representing how data flows between functional components of an example for artificial-intelligence-assisted content processing of virtual communications according to the present disclosure.

In FIG. 1, a storage device 110 storage data relevant to patients and providers. The data may be specific to a single provider or may be stored for multiple providers. For example, the data may include electronic medical records (EMRs) and electronic health records (EHRs) for patients of one or more providers, which might include provider notes from visits, diagnoses, prescriptions, and measurement data, such as weight, blood glucose, blood work, etc.

Although shown as a single entity, the storage device 110 may include multiple instances and types of data storage. For example, the storage device 110 may include one or more of a relational data store, a data lake, a column store, etc. Further, the storage device 110 may be distributed across one or more physical devices, servers, data centers, regions, etc.

In various implementations, the storage device 110 stores order data 118, member data 120, claims data 122, drug data 124, prescription data 126, and/or plan sponsor data 128. The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with a pharmacy benefit manager (PBM). The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history—including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126. Order data 118 can also be linked to the telehealth visit score of the provider. If the provider has a failing scores of a visit that exceed a threshold, the order data may assign a hold or review status to the order data. Orders placed (e.g., prescribed) by provider with a passing score or a history of passing scores by the model.

The plan sponsor data 128 includes information regarding the plan sponsors of the PBM. Examples of the plan sponsor data 128 include company name, company address, contact name, contact telephone number, contact e-mail address, etc.

### Data Flow

A provider module 130 makes relevant portions of the data from the storage device 110 available to a provider device 134. The provider device 134 is operated by a provider, such as a doctor, nurse, physician's assistant, etc. Based on the identity of the provider operating the provider device 134, the provider module 130 may allow access to only a subset of the data that is relevant to provision of service by the provider.

A virtual interaction platform 138 allows the provider to interact with a patient through a patient device 142. This interaction may be referred to as a virtual visit, virtual interaction, or virtual consultation. Each of the provider device 134 and the patient device 142 may be a desktop computer, a laptop computer, a tablet, a smartphone, etc.

The operators of the virtual interaction platform 138 may define rules for the virtual interaction. These rules may be based on laws, regulations, medical best practices, legal best practices, patient preferences, health insurer preferences, etc. In various implementations, the provider may be responsible for knowing and following these rules during the virtual interaction. In various implementations, examples of these rules include beginning the virtual interaction with verifying the patient's name, the patient's date of birth, the patient's location, the patient's medication list, the patient's medical history, the patient's allergies, etc. The rules may also include the provider fully introducing themselves and clearly indicating that the virtual interaction is being recorded. The recording may take the form of audio, which may be supplemented by video.

Further, if the patient date of birth is below an age threshold—for example, the age of majority (18 in some jurisdictions) or another threshold, such as 13 (the age specified by the Children's Online Privacy Protection Act of 1998)—the provider needs to verify that a guardian is present for the minor. This verification may take the form of the minor verifying that the guardian is present or the guardian themselves verifying their presence.

Historically, to ensure that the defined rules are being followed, specially tasked quality reviewers may review the recordings of the virtual interactions. This ad hoc quality review is expensive and time-consuming and means that only a small sampling of interactions can be verified. According to the present disclosure, artificial intelligence is leveraged to increase the coverage of interaction review, exceeding 90%, exceeding 95%, and possibly up to 100%.

In the example of FIG. 1, audio data is provided to a transcription module 146. In various implementations, the audio data may be a blob—that is, a single file, such as an MP3 file or other compressed or uncompressed audio or audiovisual file. In other implementations, the audio may be transmitted in a stream or in chunks, which may allow the transcription module 146 to begin transcribing the audio before the interaction has completed. A streaming approach also means that, if bandwidth is functionally limited, transcription can begin before the entire audio file is received by the transcription module 146. The transcription module 146 generates text, which may use machine-learning-assisted speech recognition. This text captures the audio component of the virtual interaction. In various implementations, the text may be labeled with speaker tags to identify which party is speaking. In various implementations, the transcription module 146 may incorporate a custom dictionary with medical terms to enhance transcription accuracy. The text may be plaintext, such as ASCII plaintext, and may include XML tags to define elements of the text, such as recording time and speaker. For example, a tag for recording time may be inserted at certain places (or on a regular basis, such as every 30 seconds of recording) to allow the text to be synchronized to the recording.

The text is provided to a generative artificial intelligence (AI) module 150. Based on a set of prompts from an AI instruction module 154, the generative AI module 150 provides answers to these prompts. Each prompt corresponds to an analysis and so the output is a set of these analyses. An analysis storage module 158 stores the output. Some or all of the analyses may be provided to the provider module 130 as quality data to improve the provider's adherence to the rules.

An assessment module 162 assesses the set of analyses. For example, the assessment module 162 may calculate a score for each interaction. In various implementations, the score may simply be the number of rules that were correctly followed. In various implementations, the assessment module 162 may generate a pass/fail indication. This pass/fail indication may be based on how many rules were followed. For example, if the provider deviated from two or fewer rules, this might be considered a pass, while three or more rule deviations would be considered a fail.

In various implementations, there may be a hierarchy of rules such that—for a subset of rules—deviation from any one rule in the subset results in a fail in every instance. The assessment module 162 may encode Boolean and algebraic logic for determining whether an interaction was a success or failure as well as algorithms to calculate a score. For example, deviation from a high priority rule may automatically result in a score of zero. Otherwise, if the highest priority rules are all followed, the score may reflect the adherence to the lower priority rules. The assessment then is stored by the analysis storage module 158.

In various implementations, each analysis of the set of analyses may be associated with satisfaction criteria to assess the analysis. The satisfaction criteria may be as simple as specifying that a certain analysis should specify TRUE to be considered a success. For example, this might correspond to a rule that the provider introduced themselves.

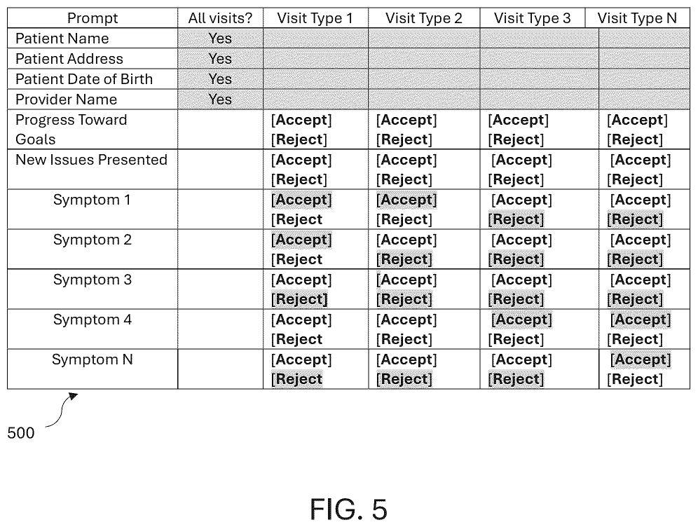

An administration module 166 allows an administrator, via an administrator device 170, to monitor the adherence of providers. For example, the assessment module 162 may also calculate overall provider scores, such as by averaging the interaction scores across all of a provider's interactions. The assessment module 162 may use an exponentially weighted average to more strongly weight more recent interactions. The assessment module 162 may also perform other statistical analyses across various categories, such as type of provider, provider network, provider location, etc. The administration module 166, via the administrator device 170, can provide a graphical user interface (se, e.g., FIG. 5) that displays the weights for a weighted average, a list of scoring components (available and to include or not include), lists of types of visits that can be selected to show the types of rules for which the model will test related to the type of visit.

The administration module 166 may also, based on input received by the administrator device 170, define criteria for the desired rules. These criteria are stored in the AI instruction module 154. In various implementations, each rule or aspect of a rule may be encoded as a separate prompt. As one example, the prompt for whether the provider introduced themselves may include the natural language query “Did the provider say their name, their license status, and the State in which their license is valid?” In an example, the model separates these multiple medical heath inquires for a visit into separate inquires or prompts. When the model determines that it is more efficient to combine inquires, it can combine inquiries into a single prompt. Combining the inquiries into a single prompt can be based on the proximity of the past answers to the rules for multiple inquiries being found at a similar time in the telehealth recording or the telehealth transcript. In various implementations, the AI instruction module 154 may automatically translate the rule criteria into prompts.

In other implementations, the administrator device 170 may be used to provide specific prompt data, such as phrases and questions, to the AI instruction module 154. In various implementations, the AI instruction module 154 may autonomously adapt the prompts based on feedback regarding how accurately the generative artificial intelligence module 150 has assessed adherence to or deviation from a rule.

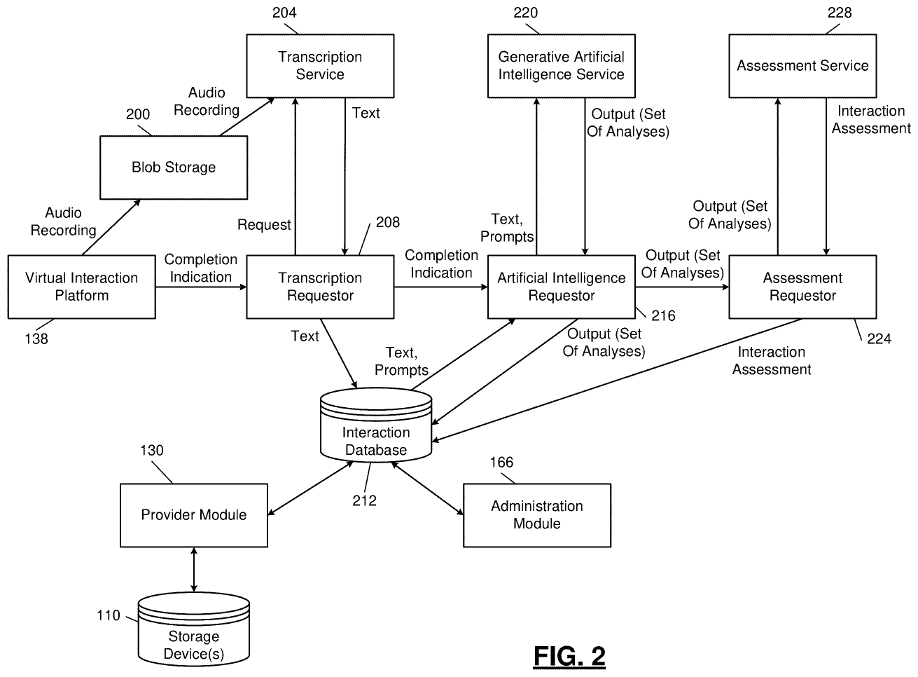

FIG. 2 is an example functional block diagram of an example service-based implementation of the present disclosure. The implementation includes blob storage 200, which stores blobs of data, including audio recordings from the original interaction platforms. The blob storage 200 can then provide the required audio recording to a transcription service 204. Upon completion of a virtual interaction, the virtual interaction platform 138 communicates a completion indication message to a transcription requestor 208. For example, the completion indication may be sent using a publish/subscribe model, such as one based on Kafka by the Apache Software Foundation or the RabittMQ messaging broker.

The transcription requestor 208 transmits a request to the transcription service 204. The request may indicate the specific audio recording for the transcription service 204 to retrieve from the blob storage 200. The transcription service 204 responds with transcribed text, which the transcription requestor 208 provides to an interaction database 212. For example, the interaction database 212 may include a relational database, such as a structured query language (SQL) database.

Upon completion of transcription, the transcription requestor 208 communicates a completion indication to an artificial intelligence requestor 216. The artificial intelligence requestor 216 provides text of the interaction along with a set of prompts to a generative artificial intelligence service 220. The set of prompts may be universal for all interactions or may vary based on the interaction.

In various implementations, different types of providers may have different rules and therefore different sets of prompts may be used. For example, the rules about presenting credentials may be different for board-certified positions versus registered nurses. Further, the set of prompts may be based on the patient. For example, a condition associated with the patient may prompt additional rules to be applicable. For example, a patient with a current diagnosis of hypertension may trigger a rule that the provider must seek information about the patient's recent blood pressure readings.

The generative artificial intelligence service 220 generates outputs based on each of the prompts. The analysis resulting from each of the prompts is provided in a set of analyses to the artificial intelligence requestor 216. In various implementations, the output may be structured, either by the generative artificial intelligence service 220 itself or by some transformation process, into a specific data format, such as JavaScript Object Notation (JSON) or Extensible Markup Language (XML). In various implementations, the transformation service may translate certain data into other data types, such as Boolean or integer.

The artificial intelligence requestor 216 stores the output into the interaction database 212 and provides the output to an assessment requestor 224. The assessment requestor 224 provides the output to an assessment service 228, which responds to the assessment requestor 224 with an interaction assessment. For example, the interaction assessment may include a numeric score, a pass/fail indication, etc. The assessment requestor 224 stores the interaction assessment into the interaction database 212. The interaction database 212 is accessible to the provider module 130 and to the administration module 166.

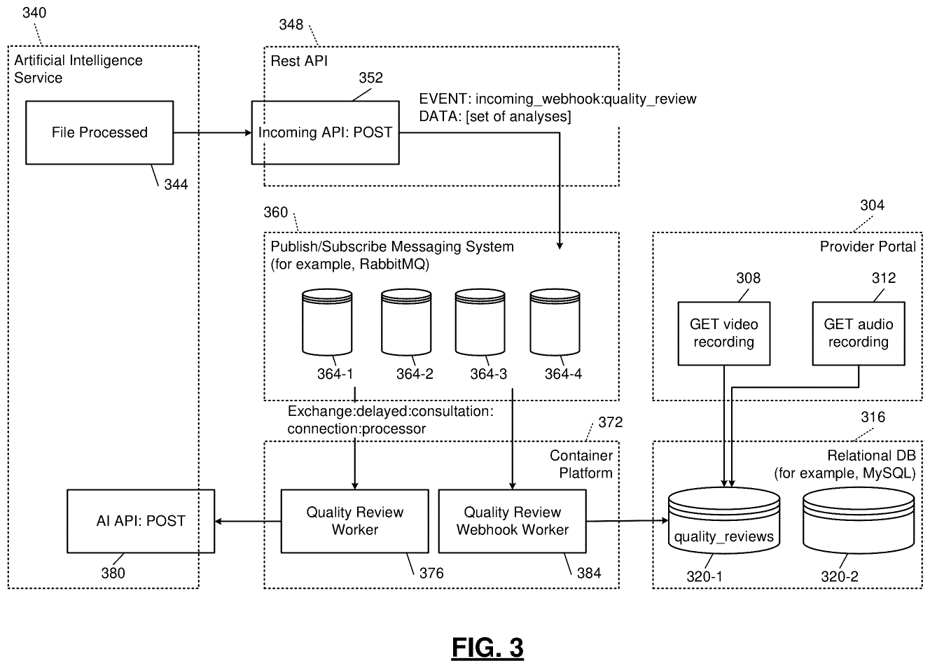

In FIG. 3, an example of data flow includes a provider portal 304, in which a GET method for a video recording is invoked at 308. In addition, a GET method for an audio recording is invoked at 312. These recordings are provided to a relational database system 316, which may be based on, for example, MySQL. A quality reviews database 320-1 stores references to—or the actual audiovisual data of—the recordings. Another database 320-2 in the relational database system 316 is shown simply for illustrative purposes.

In an artificial intelligence service 340, a file processed event 344 may be communicated to a representational state transfer (REST) application program interface (API) using a POST method. The REST API 348 has an incoming API that is accessed by the POST method, represented at 352. The data received through the POST method includes an indicator of the event, which in this example is called incoming_webhook:quality_review. The data also includes a representation of the set of analyses. For example, the data could be a JSON object or a simple object access protocol (SOAP) message. A publish/subscribe messaging system 360, which may be based on the RabbitMQ message broker system, receives the quality review event and distributes it to subscribers. For illustration only, the messaging system 360 is shown with four messaging queues 364-1, 364-2, 364-3, and 364-4.

In a container platform 372—which may be based on the Docker containerization platform and managed by the Kubernetes management system—a quality review worker 376 initiates the artificial intelligence service 340 using a POST method, represented at 380. The POST method 380 may indicate what text to process according to a set of prompts. A quality review webhook worker 384 receives data about the set of analyses via the messaging system 360 and provides this data to the quality reviews database 320-1.

### Flowchart

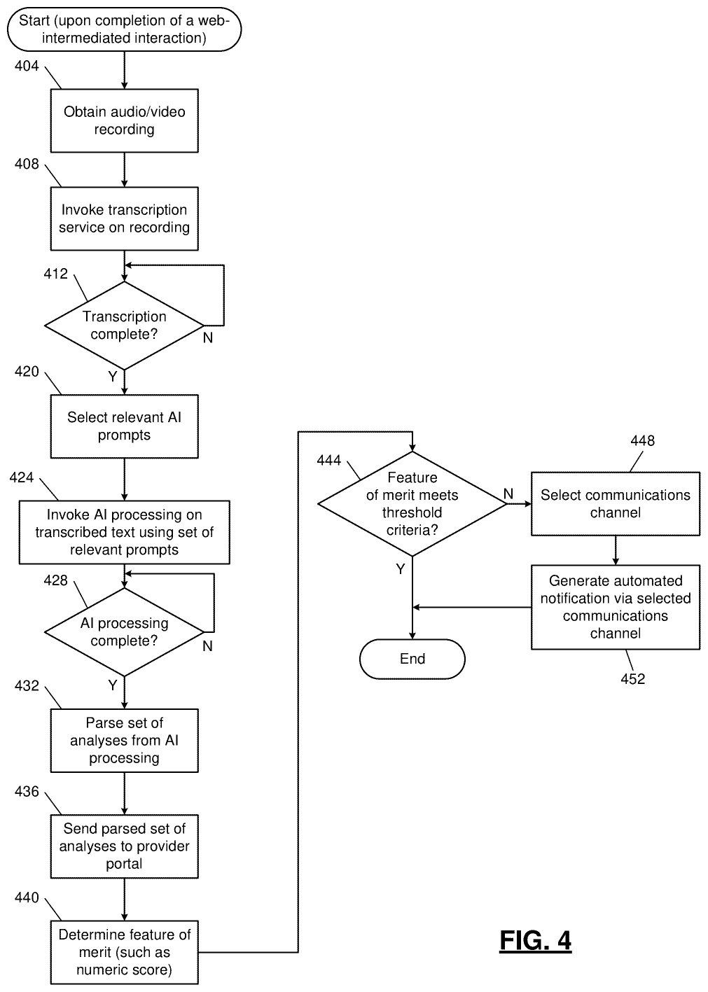

In FIG. 4, a flowchart shows control being initiated upon completion of a web-intermediated interaction, such as a video interaction between a provider and a patient. At 404, control obtains an audio/video recording of the interaction. At 408, control invokes a transcription service on the recording. At 412, control determines whether the transcription is complete. If so, control transfers to 420; otherwise, control remains at 412.

At 420, control selects relevant artificial intelligence (AI) prompts corresponding to the provider and the interaction. At 424, control invokes AI processing on the transcribed text using a set of relevant prompts. At 428, control determines whether AI processing is complete. If so, control transfers to 452; otherwise, control remains at 428. At 432, control parses a set of analyses generated by the AI processing. For example, the parsing may include extract/transform/load (ETL) operations, which may involve the execution of custom code. In various implementations, the ETL operations may include converting data from one data type to another. For example, the ETL operations may transform a string to a tristate value with a case-insensitive mapping of:
“true”->1
“false”->0
any other value->−1

At 436, control sends the set of parsed analyses to a provider portal for access by the provider.

At 440, control determines a feature of merit, such as a numeric score. At 444, if the feature of merit meets threshold criteria, control ends; otherwise, control transfers to 448. The threshold criteria may be, for example, a threshold score that must be exceeded. For example, if that score is not exceeded, there may be some flaw in the interaction that requires further review of the interaction or other actions, such as contacting the patient. At 448, control selects a communications channel over which to transmit a notification. At 452, control generates and transmits automated notification via the selected communications channel. For example, the selected communications channel may be a queue of interactions to review by a human reviewer. In other implementations, the communications channel includes emails, texts, in-browser notifications, smartphone notifications, etc. Control then ends.

FIG. 5 shows a graphical user interface 500 that can be displayed to allow selection of certain rules in the evaluation of a patient visit. Telehealth visits can be for a variety of medical issues (physical, mental, or behavioral health). Some rules for review of a visit are required for all telehealth visit, The types of rules that are required for any visit type are highlighted in GUI 500. For each visit type, the model will automatically investigate the record to determine if certain patient identifying information is in the record, e.g., the patent name, and patient address, patient date of birth. The model will search if the provider confirmed that the patient is the correct patient versus patient identifying information in the electronic medical records, sent to the provider device, and in the patient files, is stated in the recording of the visit. Similarly, the provider must state their name in the visit recording in all visits. These rules cannot be deselected on the GUI 500. The two prompts regarding progress toward goals and new issues presented are optional for all visit types (1, 2, 3, . . . . N). These must be selected on the device to be included in the model's review of visit records for all of the displayed Visit Types (top row of GUI 500). The GUI 500 can control selection of various symptom related rules for certain visits. For example, Symptom 1 is selected as required in visit types 1 and 2, but not required in visit types 3 and N. Symptom 2 is selected as required in visit type 1, but not required in visit types 2, 3 and N. Symptom 3 is not selected as required in any of the visit types shown, but may be required in other visit types (not shown). Symptom 4 is selected as required in both visit types 3 and N, but not required in visit types 1 and 2. This GUI 500 may only show prompts the apply to a group of visit types, e.g., behavioral health, dermatology, sore throat, mental health, etc. While there may be more prompts or rules that need to be checked per visit beyond those shown in GUI 500, the number of prompts or rules are reduced for ease of illustration. As stated herein, the quantity of data and the number of rules generally prohibit manual review of all or close to all of the telehealth visits. The present system can allow for a review of all of close to all visits through the use of LLM or generative AI tools described herein. The GUI 500 can provide an interface that changes based on rules that may related to a displayed visit type.

The present disclosure can be used with reviewing interactions between a medical provider and a patient (e.g., video interactions, web-intermediated interactions, electronic communication interactions, and the like). Examples of such an engagement are described in U.S. patent application Ser. No. 17/743,818, titled TELEHEALTH CONTROL SYSTEM AND METHOD FOR ENGAGING PROVIDERS; U.S. patent application Ser. No. 17/748,170, titled TELEHEALTH CONTROL SYSTEM AND METHOD; U.S. patent application Ser. No. 17/486,309, titled TELEHEALTH INTERACTION TRACKING SYSTEM AND METHOD; and U.S. patent application Ser. No. 18/127,227, titled MACHINE LEARNING TO PREDICT MEDICAL IMAGE VALIDITY AND TO PREDICT A MEDICAL DIAGNOSIS. The present application is related to U.S. patent application Ser. No. 18/608,586 filed May 31, 2024, titled PHYSICIAN ASSISTANT GENERATIVE MODEL and U.S. Provisional Patent Application No. 63/470,726. The entire contents of these applications (documents or applications mentioned within this application) are hereby incorporated by reference. The AI system can operate on data generated from the interactions in these patent applications. The AI system can incorporate individual tasks, process or structures into the presently described systems and methods. For example, the systems shown in FIGS. 4 and 5 of U.S. patent application Ser. No. 18/608,586, titled PHYSICIAN ASSISTANT GENERATIVE MODEL can be used to support the present methodologies described herein.

In an example embodiment, the transcript for a single interaction between a provider device and a patient device, can occur over two different communication modalities. These two modalities are merged by the AI system to rank or score the single interaction. The AI system can score each of the two modalities in the single interaction and then combine the scoring to output a single score based on the two modalities. In an example, the two different modalities can be a first video session and a telephone call. In an example, the two modalities can be a first video session and a second video session. The multiple video sessions can be separated in time, e.g., there is a time break between the two sessions. In an example, the two modalities are a video session and an in-person visit.

While various embodiments described herein discuss audio review, in some embodiments, the AI system can review the video recording for scoring of a care interaction between a provider (device) and a patient (device).

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A computer-implemented method for processing an audio recording of an interaction, the computer-implemented method comprising:
obtaining the audio recording;
automatically transcribing the audio recording into computer-readable text;
determining a set of artificial intelligence (AI) prompts corresponding to the interaction;
providing the computer-readable text and the set of AI prompts to an AI engine;
receiving a set of analyses from the AI engine corresponding to the set of AI prompts;
determining a feature of merit for the interaction based on the set of analyses; and
in response to the feature of merit, selectively generating a notification and transmitting the notification using a selected communications channel.

2. The computer-implemented method of claim 1 wherein the audio recording includes a compressed audio file.

3. The computer-implemented method of claim 1 wherein the set of AI prompts is universal to all interactions.

4. The computer-implemented method of claim 1 wherein each prompt of the set of AI prompts is a text string.

5. The computer-implemented method of claim 1 wherein the computer-readable text is plaintext.

6. The computer-implemented method of claim 1 wherein the set of analyses from the AI engine is received as a JavaScript Object Notation (JSON) object.

7. The computer-implemented method of claim 1 wherein each analysis of the set of analyses is a text string.

8. The computer-implemented method of claim 1 wherein each analysis of a subset of the set of analyses is a text string encoding a Boolean value.

9. The computer-implemented method of claim 1 further comprising:
transforming the set of analyses to create a transformed set of analyses,
wherein the feature of merit is based on the transformed set of analyses.

10. The computer-implemented method of claim 9 wherein the transforming includes converting data from a first data type to a second data type.

11. The computer-implemented method of claim 10 wherein the first data type is a string and the second data type is a Boolean.

12. The computer-implemented method of claim 1 wherein the feature of merit is a summed score and, for the interaction, each analysis of the set of analyses contributes either zero or one to the summed score.

13. The computer-implemented method of claim 12 wherein the feature of merit is automatically set to a failing score in response to any one or more of a defined subset of the set of analyses failing to meet satisfaction criteria.

14. The computer-implemented method of claim 1 wherein elements of the set of analyses correspond one-to-one with elements of the set of AI prompts.

15. A computer system comprising:
memory hardware configured to store instructions, and
processing hardware configured to execute the instructions, wherein the instructions include:
obtaining an audio recording of an interaction;
automatically transcribing the audio recording into computer-readable text;
determining a set of artificial intelligence (AI) prompts corresponding to the interaction;
providing the computer-readable text and the set of AI prompts to an AI engine;
receiving a set of analyses from the AI engine corresponding to the set of AI prompts;
determining a feature of merit for the interaction based on the set of analyses; and
in response to the feature of merit, selectively generating a notification and transmitting the notification using a selected communications channel.

16. The computer system of claim 15 wherein the instructions include:
transforming the set of analyses to create a transformed set of analyses,
wherein the feature of merit is based on the transformed set of analyses.

17. The computer system of claim 15 wherein the feature of merit is a summed score and, for the interaction, each analysis of the set of analyses contributes either zero or one to the summed score.

18. The computer system of claim 17 wherein the feature of merit is automatically set to a failing score in response to any one or more of a defined subset of the set of analyses failing to meet satisfaction criteria.

19. The computer system of claim 15 wherein elements of the set of analyses correspond one-to-one with elements of the set of AI prompts.

20. A non-transitory computer-readable medium comprising processor-executable instructions that include:
obtaining an audio recording of an interaction;
automatically transcribing the audio recording into computer-readable text;
determining a set of artificial intelligence (AI) prompts corresponding to the interaction;
providing the computer-readable text and the set of AI prompts to an AI engine;
receiving a set of analyses from the AI engine corresponding to the set of AI prompts;
determining a feature of merit for the interaction based on the set of analyses; and
in response to the feature of merit, selectively generating a notification and transmitting the notification using a selected communications channel.
